(19) United States
(12) Patent Application Publication
(10) Pub. No.: US 2026/0093117 A1
(43) Pub. Date: Apr. 2, 2026

(54) OPTICAL SYSTEM AND DISPLAY APPARATUS

(71) Applicant: CANON KABUSHIKI KAISHA, Tokyo (JP)

(72) Inventor: Kazutaka INOGUCHI, Tokyo (JP)

(21) Appl. No.: 19/312,631

(22) Filed: Aug. 28, 2025

(30) Foreign Application Priority Data
Oct. 2, 2024 (JP) 2024-172958

(51) Int. Cl. G02B 27/01; G02B 27/28

(52) U.S. Cl. CPC G02B 27/0172; G02B 27/288; G02B 2027/0114; G02B 2027/0138

(57) ABSTRACT

An optical system includes a first transmissive reflective surface configured to transmit first linearly polarized light and reflect second linearly polarized light, a second transmissive reflective surface disposed on an observation side of the first transmissive reflective surface and configured to transmit a part of incident light and reflect another part regardless of a polarization direction of the incident light, and an absorptive polarizer disposed on the observation side of the second transmissive reflective surface and configured to transmit third linearly polarized light and absorb fourth linearly polarized light having a polarization direction different from that of the third linearly polarized light. At least a part of the optical system guides second wavelength light, which is incident from the observation side and has a wavelength range different from that of the first wavelength light, to an imaging system. Predetermined inequalities are satisfied.

### BACKGROUND

### Field of the Technology

The aspect of the disclosure relates to one or more embodiments of an optical system for a display apparatus, such as a head mounted display (HMD).

### Description of the Related Art

An example of such an optical system is one that folds an optical path from a display element to the observer's eye (observation side) using two transmissive reflective surfaces. Japanese Patent Application Laid-Open No. 2005-148655 discloses an optical system in which a transmissive reflective surface on the display element side is a polarizing beam splitter (PBS), and a transmissive reflective surface on the observation side is a half-mirror.

U.S. Pat. No. 11,301,036 discloses an HMD that includes an optical system that folds an optical path, and an imaging system that images the observer's eye to detect a line of sight.

### SUMMARY

One or more embodiments of an optical system configured to guide first wavelength light from a display element to an observation side according to one or more aspects of the disclosure may include a first transmissive reflective surface configured to transmit first linearly polarized light and reflect second linearly polarized light having a polarization direction different from that of the first linearly polarized light, a second transmissive reflective surface disposed on the observation side of the first transmissive reflective surface and configured to transmit a part of incident light and reflect another part regardless of a polarization direction of the incident light, and an absorptive polarizer disposed on the observation side of the second transmissive reflective surface and configured to transmit third linearly polarized light and absorb fourth linearly polarized light having a polarization direction different from that of the third linearly polarized light. At least a part of the optical system may guide second wavelength light, which is incident from the observation side and has a wavelength range different from that of the first wavelength light, to an imaging system. The following inequalities may be satisfied:

$$Ts 11 / Tp 11 \leq 0.1$$

$$Ts 21 / Tp 21 \leq 0.1$$

where Tp11 and Ts11 are transmittances of the first transmissive reflective surface for the first linearly polarized light and the second linearly polarized light of the first wavelength, respectively, and Tp21 and Ts21 are transmittances of the absorptive polarizer for the third linearly polarized light and the fourth linearly polarized light of the first wavelength, respectively. At least one of the following inequalities may be satisfied:

$$Ts 12 / Tp 12 \geq 0.5$$

$$Ts 22 / Tp 22 \geq 0.5$$

where Tp12 and Ts12 are transmittances of the first transmissive reflective surface for the first linearly polarized light and the second linearly polarized light of the second wavelength light, respectively, and Tp22 and Ts22 are transmittances of the absorptive polarizer for the third linearly polarized light and the fourth linearly polarized light of the second wavelength light, respectively. One or more display apparatuses may include one or more optical systems in accordance with one or more other aspects of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view illustrating the basic configuration of an optical system according to this embodiment.

FIGS. 2A and 2B illustrate a polarization state and optical path in arrangement example 1 of a polarizing element group in this embodiment.

FIGS. 3A and 3B illustrate a polarization state and optical path in arrangement example 2 of a polarizing element group in this embodiment.

FIGS. 4A and 4B illustrate a spectral transmittance characteristic of a PBS and a linear polarizer in the embodiment.

FIG. 5 illustrates the configuration of a display apparatus according to a first embodiment.

FIG. 6 illustrates an infrared optical path in the first embodiment.

FIG. 7 illustrates the configuration of a display apparatus according to a second embodiment.

FIGS. 8A and 8B illustrate an infrared optical path in the second embodiment.

FIGS. 9A and 9B illustrate an infrared optical path in a third embodiment.

FIG. 10 illustrates the configuration of a display apparatus according to a fourth embodiment.

FIG. 11 illustrates the configuration of a display apparatus according to a fifth embodiment.

FIG. 12 illustrates an optical system in a display apparatus according to a sixth embodiment.

FIG. 13 illustrates an optical system of a display apparatus according to a seventh embodiment.

FIG. 14 illustrates a specific example of the display apparatuses according to the first to seventh embodiments.

FIG. 15 illustrates another specific example of the display apparatuses according to the first to seventh embodiments.

### DESCRIPTION OF THE EMBODIMENTS

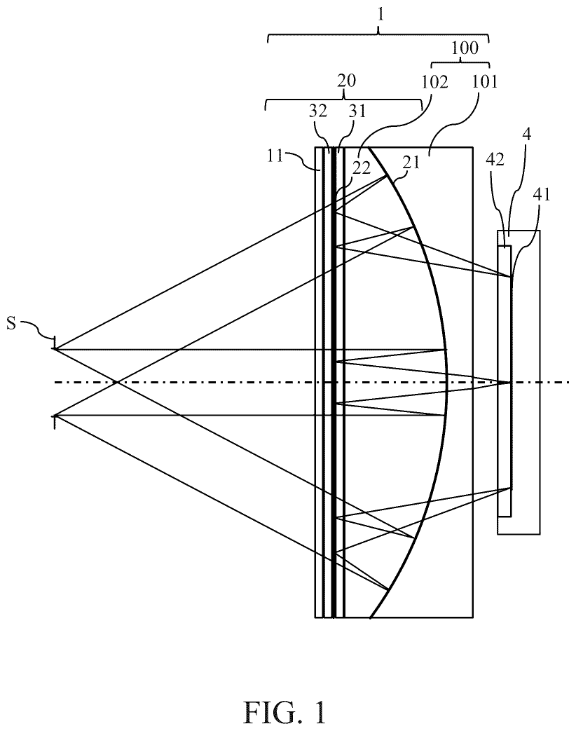

Referring now to the accompanying drawings, a description will be given of embodiments according to the disclosure. FIG. 1 illustrates the basic configuration of a display system in a display apparatus according to this embodiment. The display apparatus is used as an electronic viewfinder (EVF) or the like provided in an image pickup apparatus such as an HMD or a digital camera.

The display system includes a display element 4 and an optical system 1 that guides light in a first wavelength range (referred to as first wavelength light hereinafter) from the display element 4 to an exit pupil (pupil surface) S on the observation side. The observer's eye is placed near the exit pupil S.

The display element 4 includes an organic EL element or a liquid crystal element, and forms an original image on a display surface 41, and emits image light as first wavelength light corresponding to an original image from the display surface 41. The display surface 41 is covered by a cover glass or another flat plate portion 42 including a parallel plate having no refractive power.

The optical system 1 includes a lens unit 100 including a plano-concave lens 101 and a plano-convex lens 102 arranged in this order from the display element side. The plano-concave lens 101 and the plano-convex lens 102 are made of the same medium and are cemented together.

The optical system 1 further includes a polarizing element group 20 for forming a triple path as a folded optical path. The polarizing element group 20 includes a first transmissive reflective surface 21, a first quarter waveplate 31, a second transmissive reflective surface 22, a second quarter waveplate 32, and a linear polarizer 11, arranged in this order from the display element side to the observation side.

The first transmissive reflective surface 21 is a polarizing beam splitter (PBS) that transmits first linearly polarized light of the incident light and reflects second linearly polarized light having a polarization direction different from (orthogonal to) that of the first linearly polarized light, that is, a reflective polarizer with polarization selectivity. In the following description, the first transmissive reflective surface 21 will be referred to as a PBS 21. The PBS 21 is formed on the curved surface (cemented surface) of at least one of the plano-concave lens 101 and the plano-convex lens 102.

The second transmissive reflective surface 22 is a half-mirror that transmits a part of the incident light and reflects the other part regardless of the polarization direction and wavelength of the light. In the following description, the second transmissive reflective surface 22 will be referred to as the half-mirror 22. The half-mirror 22 is formed between the first quarter waveplate 31 and the second quarter waveplate 32 so as to be cemented to them. The transmittance and reflectance of the half-mirror 22 do not necessarily have to be 50%:50%.

The first quarter waveplate 31 is cemented to a flat surface on the observation side of the plano-convex lens 102, and the second quarter waveplate 32 is cemented to the linear polarizer 11.

The linear polarizer 11 is an absorptive polarizer that transmits third linearly polarized light in the incident light and absorbs fourth linearly polarized light having a polarization direction different from (orthogonal to) that of the third linearly polarized light. In this embodiment, the third linearly polarized light is linearly polarized light having the same polarization direction as that of the second linearly polarized light, and the fourth linearly polarized light is linearly polarized light having the same polarization direction as that of the first linearly polarized light. The linear polarizer 11 is cemented to the flat surface of the observation side of the second quarter waveplate 32. Thus, the optical system 1 is configured as an integrated optical component, and thereby, the positions of the optical system 1 and the display element 4 are easily adjustable.

The PBS 21 and the linear polarizer 11 are arranged so that the directions of their transmission axes are parallel (same) or orthogonal to each other. The first quarter waveplate 31 and the second quarter waveplate 32 are arranged so that the directions of their slow axes are parallel or orthogonal to each other. Depending on the combination of the directions of these transmission axes and slow axes, the third linearly polarized light and the fourth linearly polarized light are linearly polarized lights in the same polarization direction as those of the first linearly polarized light and the second linearly polarized light, respectively, or linearly polarized lights in the same polarization direction as those of the second linearly polarized light and the first linearly polarized light, respectively.

In the optical system 1 having the above basic configuration, the first wavelength light emitted from the display surface 41 passes through the flat plate portion 42 and enters the optical system 1 from the flat surface of the plano-concave lens 101 on the display element side. The first linearly polarized light of the first wavelength light that has transmitted through the plano-concave lens 101 transmits through the PBS 21 and enters the plano-convex lens 102. A part of the first wavelength light as circularly polarized light that has transmitted through the plano-convex lens 102 and the first quarter waveplate 31 is reflected by the half-mirror 22, and is converted into the second linearly polarized light by transmitting again through the first quarter waveplate 31. The first wavelength light as the second linearly polarized light is then reflected by the PBS 21 after transmitting through the plano-convex lens 102, and is converted into circularly polarized light by transmitting again through the plano-convex lens 102 and the first quarter waveplate 31, and enters the half-mirror 22. The first wavelength light as circularly polarized light that has transmitted through the half-mirror 22 is converted into the third linearly polarized light by the second quarter waveplate 32, and transmits through the linear polarizer 11 to reach the exit pupil S.

A description will now be given of the polarization state and optical path of the first wavelength light in specific arrangement examples 1 and 2 of the polarizing element group 20 in the optical system 1. Now assume that both the first transmissive reflective surface (PBS) 21 and the linear polarizer 11 have ideal polarization characteristics. The plano-concave lens 101 and the plano-convex lens 102 are not illustrated.

### Arrangement Example 1

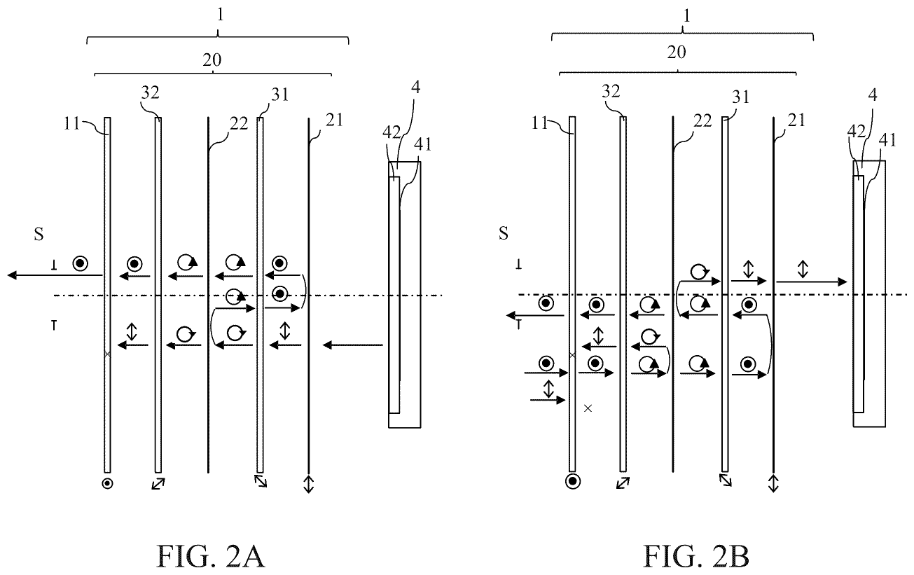

FIG. 2A illustrates a polarization state and optical path of image light as the first wavelength light in arrangement example 1. As illustrated in the lower part in FIG. 2A, the direction of the transmission axis of the PBS 21 (i.e., the polarization direction of the first linearly polarized light) and the direction of the transmission axis of the linear polarizer 11 are orthogonal to each other. In addition, the direction of the slow axis of the first quarter waveplate 31 and the direction of the slow axis of the second quarter waveplate 32 are tilted by +45° and −45°, respectively, relative to the polarization direction of the first linearly polarized light when viewed from the observation side, and are orthogonal to each other. The clockwise and counterclockwise circular polarizations below refer to clockwise and counterclockwise circular polarizations when viewed in the light traveling direction. Viewing in the light traveling direction refers to a rotating direction when observed from the display element side toward the pupil S in the case of light traveling toward the display element side (right side in FIG. 2A), and a rotating direction when observed from the pupil side toward the display element side in the case of light traveling toward the pupil side (left side in FIG. 2A).

The image light from the display surface 41 of the display element 4 passes through the flat plate portion 42 and enters the polarizing element group 20 of the optical system 1. The first linearly polarized light of the image light transmits through the PBS 21 and is converted into clockwise circularly polarized light while transmitting through the first quarter waveplate 31. A part of the clockwise circularly polarized light transmits through the half-mirror 22 and is converted into the fourth linearly polarized light having the same polarization direction as that of the first linearly polarized light while transmitting through the second quarter waveplate 32. The fourth linearly polarized light is absorbed by the linear polarizer 11.

On the other hand, a part of the clockwise circularly polarized light from the first quarter waveplate 31 is reflected by the half-mirror 22 and becomes counterclockwise circularly polarized light. The counterclockwise circularly polarized light is converted into the second linearly polarized light while transmitting through the first quarter waveplate 31 again. The second linearly polarized light reflected by the PBS 21 is converted into the counterclockwise circularly polarized light while transmitting through the first quarter waveplate 31 again. The counterclockwise circularly polarized light passes through the half-mirror 22 and is converted into the third linearly polarized light having the same polarization direction as that of the second linearly polarized light while transmitting through the second quarter waveplate 32. The third linearly polarized light transmits through the linear polarizer 11 and reaches the exit pupil S.

FIG. 2B illustrates a polarization state and optical path of external light (ghost light) as the first wavelength light incident from the observation side in the arrangement example 1. The fourth linearly polarized light having the same polarization direction as that of the first linearly polarized light among the external light incident from the observation side to the optical system 1 is absorbed by the linear polarizer 11. The third linearly polarized light having the same polarization direction as that of the second linearly polarized light among the external light passes through the linear polarizer 11 and is converted into the counterclockwise circularly polarized light while transmitting through the second quarter waveplate 32. The counterclockwise circularly polarized light reflected by the half-mirror 22 becomes clockwise circularly polarized light and is converted to the fourth linearly polarized light while transmitting through the second quarter waveplate 32. The fourth linearly polarized light returns to the linear polarizer 11 and is absorbed.

On the other hand, the counterclockwise circularly polarized light that has transmitted through the half-mirror 22 is converted to the second linearly polarized light while transmitting through the first quarter waveplate 31. The second linearly polarized light is reflected by the PBS 21 and is converted to counterclockwise circularly polarized light while transmitting through the first quarter waveplate 31 again. The counterclockwise circularly polarized light that has transmitted through the half-mirror 22 is converted to the first linearly polarized light while transmitting through the second quarter waveplate 32 again. The first linearly polarized light passes through the PBS 21 and the flat plate portion 42 to reach the display surface 41. A part of the counterclockwise circularly polarized light is reflected by the half-mirror 22 and becomes clockwise circularly polarized light, and the clockwise circularly polarized light is converted to the second linearly polarized light while transmitting through the first quarter waveplate 31. The second linearly polarized light is reflected by the PBS 21, and converted into counterclockwise circularly polarized light while transmitting through the first quarter waveplate 31 again. Of the counterclockwise circularly polarized light, the light that has transmitted through the half-mirror 22 is converted into third linearly polarized light while transmitting through the second quarter waveplate 32 again. The third linearly polarized light transmits through the linear polarizer 11 toward the observation side.

The counterclockwise circularly polarized light converted from the second linearly polarized light by the first quarter waveplate 31 is reflected by the half-mirror 22 and becomes clockwise circularly polarized light. The clockwise circularly polarized light is polarized into the first linearly polarized light while transmitting through the first quarter waveplate 31 again. The first linearly polarized light transmits through the PBS 21 and the flat plate portion 42 to reach the display surface 41.

Thus, only the external light reflected once by the PBS 21 may be guided to the observation side by the optical system 1.

### Arrangement Example 2

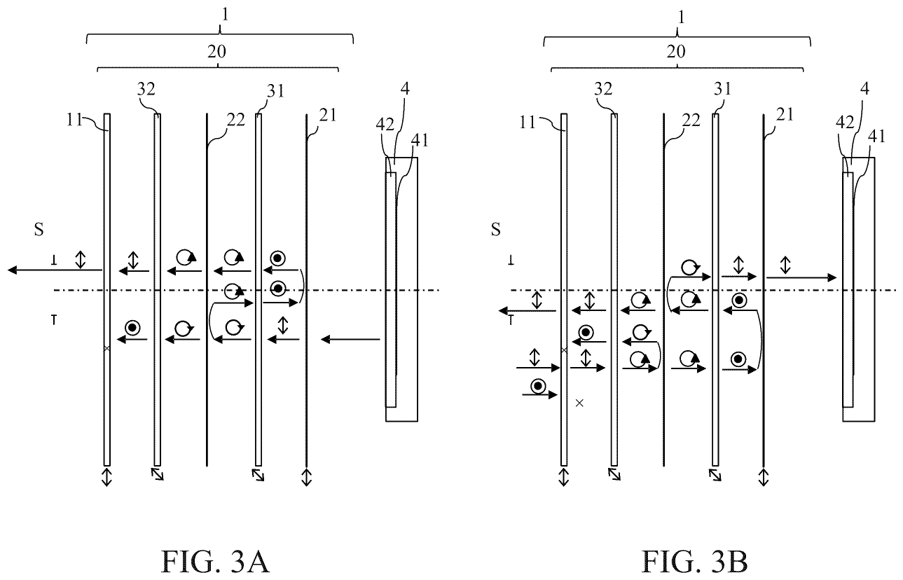

FIG. 3A illustrates a polarization state and optical path of image light as the first wavelength light in an arrangement example 2. As illustrated in the lower part of FIG. 3A, the direction of the transmission axis of the PBS 21 (polarization direction of the first linearly polarized light) and the direction of the transmission axis of the linear polarizer 11 are parallel to each other. In addition, the direction of the slow axis of the first quarter waveplate 31 and the direction of the slow axis of the second quarter waveplate 32 are both tilted by +45° relative to the polarization direction of the first linearly polarized light when viewed from the observation side, and are parallel to each other. The clockwise and counterclockwise circularly polarized light below refer to clockwise and counterclockwise circularly polarized light when viewed in the light traveling direction.

The image light from the display surface 41 of the display element 4 transmits through the flat plate portion 42 and enters the polarizing element group 20 of the optical system 1. The first linearly polarized light of the image light transmits through the PBS 21 and is converted into clockwise circularly polarized light while transmitting through the first quarter waveplate 31. A part of the clockwise circularly polarized light transmits through the half-mirror 22 and the second quarter waveplate 32 and is converted into the fourth linearly polarized light having the same polarization direction as that of the second linearly polarized light. The fourth linearly polarized light is absorbed by the linear polarizer 11.

A part of the clockwise circularly polarized light is reflected by the half-mirror 22 and becomes counterclockwise circularly polarized light. The counterclockwise circularly polarized light transmits again through the first quarter waveplate 31 and is converted into the second linearly polarized light. The second linearly polarized light reflected by the PBS 21 transmits again through the first quarter waveplate 31 and is converted into counterclockwise circularly polarized light. The counterclockwise circularly polarized light transmits through the half-mirror 22 and the second quarter waveplate 32 and is converted into third linearly polarized light having the same polarization direction as that of the first linearly polarized light. The third linearly polarized light transmits through the linear polarizer 11 and reaches the exit pupil S.

FIG. 3B illustrates a polarization state and optical path of external light (ghost light) as the first wavelength light incident from the observation side in arrangement example 2. Of the external light incident on optical system 1 from the observation side, the fourth linearly polarized light having the same polarization direction as that of the second linearly polarized light is absorbed by linear polarizer 11. Furthermore, of the external light, the third linearly polarized light having the same polarization direction as that of the first linearly polarized light transmits through linear polarizer 11 and then transmits through second quarter waveplate 32 to be converted into counterclockwise circularly polarized light. Of the counterclockwise circularly polarized light, the light reflected by half-mirror 22 becomes clockwise circularly polarized light and is converted into the fourth linearly polarized light while transmitting through second quarter waveplate 32. The fourth linearly polarized light returns to linear polarizer 11 and is absorbed.

On the other hand, the counterclockwise circularly polarized light that has transmitted through half-mirror 22 transmits through first quarter waveplate 31 to be converted into the second linearly polarized light. The second linearly polarized light is reflected by PBS 21 and is converted into counterclockwise circularly polarized light while transmitting again through first quarter waveplate 31. The counterclockwise circularly polarized light that has transmitted through the half-mirror 22 transmits through the second quarter waveplate 32 again and is converted into the first linearly polarized light. The first linearly polarized light transmits through the PBS 21 and the flat plate portion 42 and reaches the display surface 41. A part of the counterclockwise circularly polarized light is reflected by the half-mirror 22 and becomes clockwise circularly polarized light, and the clockwise circularly polarized light transmits through the first quarter waveplate 31 and is converted into the second linearly polarized light. The second linearly polarized light is reflected by the PBS 21, transmits through the first quarter waveplate 31 again and is converted into counterclockwise circularly polarized light. The counterclockwise circularly polarized light that transmits through the half-mirror 22 transmits through the second quarter waveplate 32 again and is converted into the third linearly polarized light. The third linearly polarized light transmits through the linear polarizer 11 and heads toward the observation side.

The counterclockwise circularly polarized light converted from the second linearly polarized light by the first quarter waveplate 31 is reflected by the half-mirror 22 and becomes clockwise circularly polarized light. The clockwise circularly polarized light transmits again by the first quarter waveplate 31 and is converted into the first linearly polarized light. The first linearly polarized light transmits through the PBS 21 and the flat plate portion 42 to reach the display surface 41.

Thus, the only external light that may be guided to the observation side by the optical system 1 is the external light reflected once by the PBS 21.

The optical path for displaying the image light in arrangement examples 1 and 2 follows the display element 4, the PBS 21 (transmission), the half-mirror 22 (reflection), the PBS 21 (reflection), the half-mirror 22 (transmission), the linear polarizer 11 (transmission), and the exit pupil S in this order. On the other hand, the first optical path of the external light from the observation side follows the linear polarizer 11 (transmission), the half-mirror 22 (transmission), the PBS 21 (reflection), the half-mirror 22 (transmission), the linear polarizer 11 (transmission), and the exit pupil S in this order. The second optical path of the external light follows the linear polarizer 11 (transmission), the half-mirror 22 (transmission), the PBS 21 (reflection), the half-mirror 22 (reflection), the PBS 21 (transmission), and the display element 4 in this order.

In the optical system disclosed in Japanese Patent Application Laid-Open No. 2005-148655, the optical path of the external light from the observation side is an optical path in which the light is reflected twice by PBS 21. On the other hand, in this embodiment, the optical path of the external light from the observation side is an optical path in which the light is reflected only once by the PBS (first transmissive reflective surface) 21. Thereby, this embodiment can suppress ghosts due to external light entering from the observation side.

In the optical system according to this embodiment, one of the PBS 21 and the half-mirror 22 is formed into a curved shape and acts as a reflective surface A having a light condensing power. The optical system according to this embodiment may satisfy the following inequality (1):

$$1 < LaA / fA \leq 2.5 \qquad ( 1 )$$

where fA is a focal length during reflection on the reflective surface A, and LaA is an air-equivalent optical path length from the reflection on the reflective surface A to the exit pupil S.

Satisfying inequality (1) makes it difficult for external light reflected only once by the PBS 21 to reach the exit pupil S, and can suppress ghosts.

The PBS 21 having a concave surface with concave toward the observation side as the reflective surface A is beneficial to size (or diameter) reduction of the optical system.

In this embodiment, the PBS 21 reflects linearly polarized light perpendicular to the transmission axis, and the linear polarizer 11 absorbs linearly polarized light perpendicular to the transmission axis, but the spectral characteristics of the transmittance of these polarizers can be similarly discussed. Thus, the spectral transmittance characteristics of the PBS 21 and the linear polarizer 11 will be defined as follows. A polarizer whose transmittance for linearly polarized light in a polarization direction perpendicular to the transmission axis in the infrared wavelength range (for convenience, referred to as S-polarized light hereinafter) is significantly higher than the transmittance for S-polarized light in the visible wavelength range will be referred to as an infrared-unsupported polarizer. In this infrared-unsupported polarizer, the transmittance for linearly polarized light in a polarization direction parallel to the transmission axis in the infrared wavelength range (for convenience, referred to as P-polarized light hereinafter) is equivalent to the transmittance for P-polarized light in the visible wavelength range. A polarizer whose transmittances for S-polarized light and P-polarized light in the infrared wavelength range are equivalent to the transmittances for S-polarized light and P-polarized light in the visible wavelength range will be referred to as an infrared-supported polarizer. In this infrared-supported polarizer, the transmittance for S-polarized light in the infrared and visible wavelength ranges is significantly lower than the transmittance for P-polarized light.

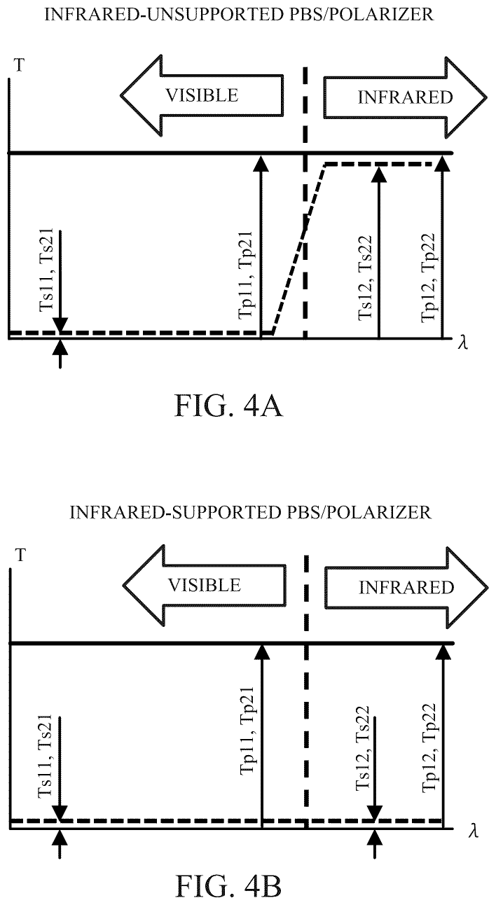

FIG. 4A illustrates the spectral transmittance characteristics of an infrared-unsupported PBS 21 and a linear polarizer 11, and FIG. 4B illustrates the spectral transmittance characteristics of an infrared-supported PBS 21 and a linear polarizer 11. In FIGS. 4A and 4B, a horizontal axis represents wavelength 2, a left side of a vertical broken line indicates a visible wavelength range, and a right side indicates an infrared wavelength range. The vertical axis represents transmittance T of each polarizer. A solid line represents the transmittance of each polarizer for linearly polarized light with a polarization direction parallel to the transmission axis (first and third linearly polarized light as P-polarized light), and a broken line indicate the transmittance of each polarizer for linearly polarized light with a polarization direction perpendicular to the transmission axis (second and fourth linearly polarized light as S-polarized light).

Tp11 and Ts11 are the transmittances of PBS 21 for the first and second linearly polarized light of the first wavelength light in the visible wavelength range, respectively, and Tp12 and Ts12 are the transmittances of PBS 21 for the first and second linearly polarized light of the second wavelength light in the infrared wavelength range, respectively. Tp21 and Ts21 are the transmittances of the linear polarizer 11 for the third and fourth linearly polarized light of the first wavelength light, respectively, and Tp22 and Ts22 are the transmittances of the linear polarizer 11 for the third and fourth linearly polarized light of the second wavelength light, respectively. FIGS. 4A and 4B illustrate that Tp11 and Tp21, Ts11 and Ts21, Tp12 and Tp22, and Ts12 and Ts22 are equal to each other, but in reality, they may have the same transmittances or different transmittances.

In the visible wavelength range, for the infrared-unsupported and infrared-supported PBS 21 and linear polarizer 11, the following relationship is ideal:

$$Tp 11 / Tp 21 = 1$$

$$Ts 11 / Ts 21 = 0$$

However, the following inequalities may be satisfied:

$$Ts 11 / Tp 11 \leq 0.1$$

$$Ts 21 / Tp 21 \leq 0.1$$

In the infrared wavelength range, for the non-infrared-supported PBS 21 and linear polarizer 11, the following relationship is ideal:

$$Tp 12 , Tp 22 = 1$$

$$Ts 12 , Ts 22 = 1$$

However, the following inequalities may be satisfied:

$$Ts 12 / Tp 12 \geq 0.5$$

$$Ts 22 / Tp 22 \geq 0.5$$

The following inequalities may be satisfied:

$$Ts 12 / Tp 12 \geq 0.8$$

$$Ts 22 / Tp 22 \geq 0.8$$

The following inequalities may be satisfied:

$$Ts 12 / Tp 12 \geq 0.9$$

$$Ts 22 / Tp 22 \geq 0.9$$

In the infrared wavelength range, for the infrared-supported PBS 21 and linear polarizer 11, the following relationship is ideal:

$$Tp 12 , Tp 22 = 1$$

$$Ts 12 , Ts 22 = 0$$

However, the following inequalities may be satisfied:

$$Ts 12 / Tp 12 < 0.5$$

$$Ts 22 / Tp 22 < 0.5$$

The following inequalities may be satisfied:

$$Ts 12 / Tp 12 \leq 0.2$$

$$Ts 22 / Tp 22 \leq 0.2$$

The following inequalities may be satisfied:

$$Ts 12 / Tp 12 \leq 0.1$$

$$Ts 22 / Tp 22 \leq 0.1$$

The optical system 1 according to this embodiment may satisfy both of the following inequalities:

$$Ts 11 / Tp 11 \leq 0.1 \qquad ( 2 )$$

$$Ts 21 / Tp 21 \leq 0.1 \qquad ( 3 )$$

In addition, the optical system 1 according to this embodiment may satisfy at least one of the following inequalities:

$$Ts 12 / Tp 12 \geq 0.5 \qquad ( 4 )$$

$$Ts 22 / Tp 22 \geq 0.5 \qquad ( 5 )$$

In a case where a reflective polarizer such as the PBS 21 is made of a dielectric multilayer film, in order to make it infrared-supported as illustrated in FIG. 4B, the number of layers in the multilayer film is to be increased compared to that in the case of not making it infrared-supported as illustrated in FIG. 4A, and as a result, the manufacturing cost increases. On the other hand, in a case where the reflective polarizer is made of a wire grid, the wavelength on the short wavelength side that can be supported is determined by the grid pitch, and the longer wavelength side basically functions as an infrared-supported polarizer as illustrated in FIG. 4B. Wire grid reflective polarizers have a wide wavelength range and low incidence angle dependence, so it is easy to achieve high contrast between the transmission axis direction and the direction perpendicular to it (it is easy to increase the extinction ratio).

In a transmissive polarizer such as the linear polarizer 11, to obtain the characteristic illustrated in FIG. 4B from the characteristic illustrated in FIG. 4A, the wavelength range of linearly polarized light that can be absorbed into the infrared range is to be expanded, and the manufacturing cost increases.

Thus, both inequalities (4) and (5) may not be satisfied, and at least one of them may be satisfied.

### First Embodiment

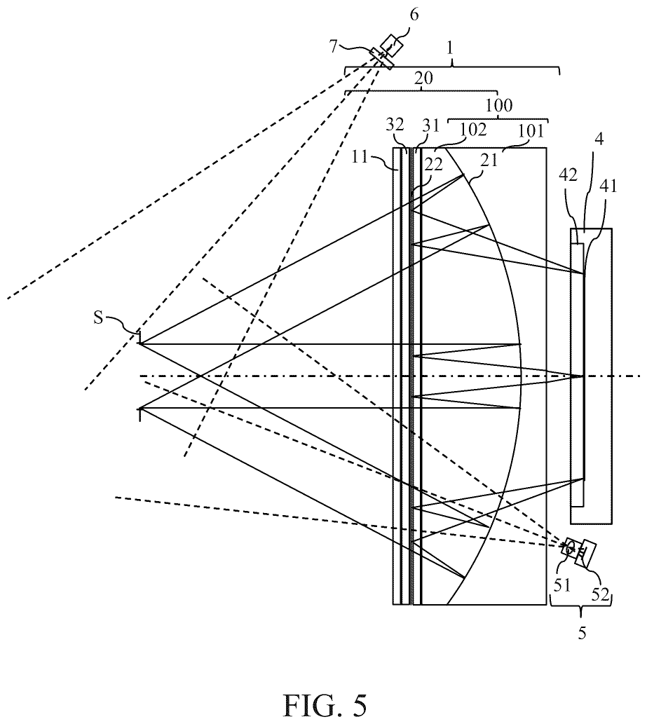

FIG. 5 illustrates the configuration of a display apparatus according to a first embodiment. This display apparatus has a configuration in which an imaging unit 5, an infrared light source 6, and a linear polarizer 7 for a light source are added as an imaging system to the display system illustrated in FIG. 1.

The imaging unit 5 includes an imaging optical system 51 and an image sensor 52. The infrared light source 6 irradiates the second wavelength light in the infrared wavelength range toward the observation side without passing through the optical system 1. The linear polarizer 7 is an absorption type polarizer that transmits linearly polarized light (having the same polarization direction as that of the fourth linearly polarized light) with a polarization direction parallel to the transmission axis of the second wavelength light from the infrared light source 6 and absorbs linearly polarized light (having the same polarization direction as the third linearly polarized light) with a polarization direction perpendicular to the transmission axis.

The second wavelength light that has been emitted from the infrared light source 6 and transmitted through the linear polarizer 7 is reflected by the eye (pupil) of the observer disposed near the exit pupil S of the optical system 1 and enters the optical system 1 from the observation side. The second wavelength light that has passed through the optical system 1 enters the imaging unit 5. The imaging unit 5 obtains information about the eye by capturing the pupil image formed by the imaging optical system 51 using the image sensor 52.

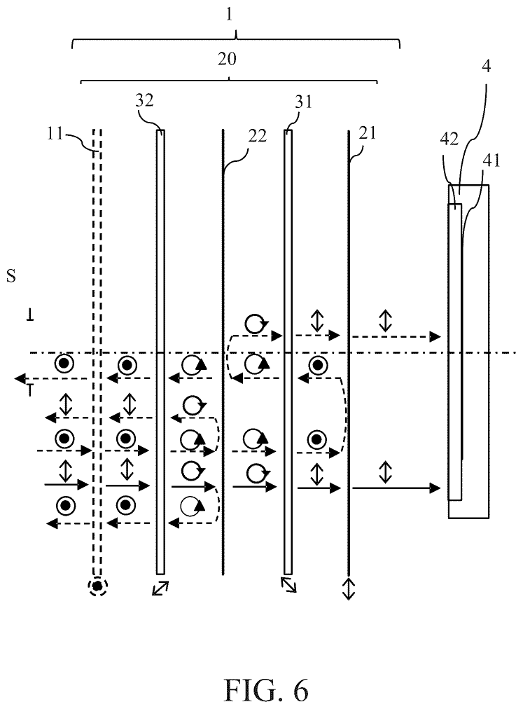

FIG. 6 illustrates the optical path of the second wavelength light in this embodiment. The arrangement of the optical system 1 according to this embodiment is the same as that in the arrangement example 1 illustrated in FIGS. 2A and 2B. However, the same arrangement as the arrangement example 2 illustrated in FIGS. 3A and 3B may be adopted, and even in this case, the optical path of the second wavelength light is similar. A description will now be given of the optical path where it is assumed that each of the PBS 21 and the linear polarizer 11 has the above ideal spectral transmittance characteristic for the second wavelength light. In this embodiment, the PBS 21 is illustrated by a solid line in the figure as being compatible with infrared light, and the linear polarizer 11 is illustrated by a broken line in the figure as being incompatible with infrared light. The infrared-supported PBS 21 can be configured with a wire grid, and in this case, a high extinction ratio can be obtained even when the range of incident angles of the image light to the PBS 21 is large. As a result, a high-contrast image can be displayed.

The second wavelength light incident on the optical system 1 from the observation side transmits through the linear polarizer 11 regardless of its polarization direction. The third linearly polarized light (having the same polarization direction as the second linearly polarized light) that transmits through the linear polarizer 11 travels an optical path similar to that of the third linearly polarized light of the external light illustrated in FIG. 2B, while its polarization state is converted, and it travels toward the observation side or the display element side. The fourth linearly polarized light that enters the optical system 1 as the third linearly polarized light and returns to the linear polarizer 11 is not absorbed by the linear polarizer 11 and exits from the optical system 1 and returns to the observation side.

The fourth linearly polarized light (having the same polarization direction as the first linearly polarized light) of the second wavelength light that transmits through the linear polarizer 11 transmits through the second quarter waveplate 32 and is converted into clockwise circularly polarized light, and a part of the clockwise circularly polarized light is reflected by the half-mirror 22 and becomes counterclockwise circularly polarized light. The counterclockwise circularly polarized light is then converted into the third linearly polarized light by transmitting through the second quarter waveplate 32 again. The third linearly polarized light is emitted from the optical system 1 without being absorbed by the linear polarizer 11 and returns to the observation side.

On the other hand, the clockwise circularly polarized light that has transmitted through the half-mirror 22 is converted to the first linearly polarized light by transmitting through the first quarter waveplate 31. The first linearly polarized light transmits through the PBS 21 to exit the optical system 1 and travels toward the display element side.

Thus, the second wavelength light that has entered the optical system 1 from the observation side as the fourth linearly polarized light transmits through the half-mirror 22 and the PBS 21 once each and travels toward the display element side. Thereby, good line-of-sight detection can be achieved through the imaging unit 5 disposed on the display element side.

The optical system 1 according to this embodiment acts as a flat plate that has no refractive power for the second wavelength light that enters the imaging unit 5 from the observation side. Thus, this embodiment can use a general-purpose infrared camera as the imaging unit 5, and as a result, can provide a display apparatus that allows good line-of-sight detection at low cost. In addition, the imaging unit 5 configured to capture a pupil image via the optical system 1 can reduce the size of the entire display apparatus. Since the imaging unit 5 can be disposed at a tilt angle smaller than the maximum display angle of view, imaging of the pupil image (i.e., line-of-sight detection) becomes easier.

In this embodiment, a single infrared light source 6 and a single imaging unit 5 are provided for one optical system 1, but the number of infrared light sources and imaging units may be multiple. This is similarly applicable to other embodiments described later.

### Second Embodiment

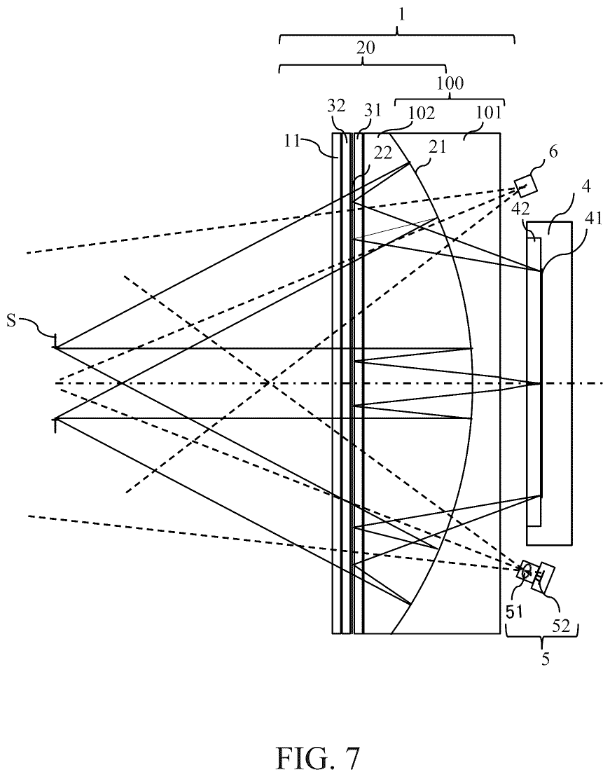

FIG. 7 illustrates the configuration of a display apparatus according to a second embodiment. This display apparatus has a configuration in which an imaging unit 5 and an infrared light source 6 are added to the display system illustrated in FIG. 1.

The imaging unit 5 includes an imaging optical system 51 and an image sensor 52. The infrared light source 6 irradiates second wavelength light in the infrared wavelength range toward the observation side via the optical system 1. In this embodiment, the second wavelength light from the infrared light source 6 is irradiated to the observation side via the entire optical system 1, but it may be irradiated to the observation side via at least a part of the optical system 1.

The second wavelength light that has been emitted from the infrared light source 6 and transmitted through the optical system 1 from the display element side is reflected by the observer's eye (pupil) located near the exit pupil S of the optical system 1 and enters the optical system 1 from the observation side. The second wavelength light that has passed through the optical system 1 enters the imaging unit 5. The imaging unit 5 acquires information about the eye by capturing a pupil image formed by the imaging optical system 51 using the image sensor 52.

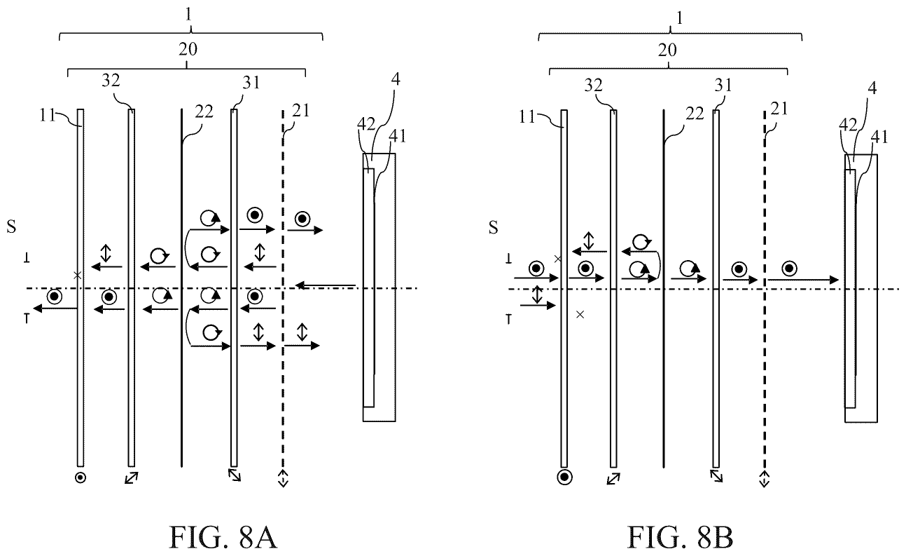

FIGS. 8A and 8B illustrate a polarization state and optical path of the second wavelength light in this embodiment. The arrangement of the optical system 1 in this embodiment is the same as that of the arrangement example 1 illustrated in FIGS. 2A and 2B. However, the same arrangement as that of the arrangement example 2 illustrated in FIGS. 3A and 3B may also be adopted, and even in this case, the optical path of the second wavelength light will be similar. A description will now be given of the optical path where it is assumed that each of the PBS 21 and the linear polarizer 11 has the ideal spectral transmittance characteristic described above for the second wavelength light. In this embodiment, the PBS 21 is illustrated by a broken line in the figure as being incompatible with infrared, and the linear polarizer 11 is illustrated by a solid line in the figure as being compatible with infrared.

FIG. 8A illustrates the polarization state and optical path of the second wavelength light emitted from the infrared light source 6 and entering the optical system 1 from the display element side. The second wavelength light emitted from the infrared light source 6 transmits through the infrared-unsupported PBS 21 regardless of its polarization direction. The second linearly polarized light of the second wavelength light that transmits through the PBS 21 transmits through the first quarter waveplate 31 and is converted into counterclockwise circularly polarized light. A part of the counterclockwise circularly polarized light transmits through the half-mirror 22 and the second quarter waveplate 32 and is converted into third linearly polarized light (having the same polarization direction as the second linearly polarized light). The third linearly polarized light transmits through the linear polarizer 11, exits the optical system 1, and travels toward the observation side.

A part of the counterclockwise circularly polarized light from the first quarter waveplate 31 is reflected by the half-mirror 22 and becomes clockwise circularly polarized light, and the clockwise circularly polarized light transmits through the first quarter waveplate 31 again and is converted into the first linearly polarized light. The first linearly polarized light transmits through the PBS 21, exits the optical system 1, and returns to the display element side.

The first linearly polarized light of the second wavelength light that has transmitted through the PBS 21 transmits through the first quarter waveplate 31 and is converted to clockwise circularly polarized light. A part of the clockwise circularly polarized light transmits through the half-mirror 22 and the second quarter waveplate 32 and is converted to fourth linearly polarized light (having the same polarization direction as the first linearly polarized light), and is absorbed by the linear polarizer 11.

A part of the clockwise circularly polarized light from the first quarter waveplate 31 is reflected by the half-mirror 22 and becomes counterclockwise circularly polarized light, which transmits through the first quarter waveplate 31 again and is converted to second linearly polarized light. The second linearly polarized light transmits through the PBS 21, exits the optical system 1, and returns to the display element side.

Thus, of the second wavelength light that enters the optical system 1 from the display element side, a light component that transmits through the PBS 21 and the half-mirror 22 once each, and further through the linear polarizer 11 travels toward the observation side.

FIG. 8B illustrates the polarization state and optical path of the second wavelength light that is reflected by the observer's eye and enters the optical system 1 from the observation side.

Of the second wavelength light that enters the optical system 1 from the observation side, the fourth linearly polarized light is absorbed by the linear polarizer 11, and the third linearly polarized light transmits through the linear polarizer 11. The third linearly polarized light that transmits through the linear polarizer 11 transmits through the second quarter waveplate 32 and is converted into counterclockwise circularly polarized light. A part of the counterclockwise circularly polarized light is reflected by the half-mirror 22 and becomes clockwise circularly polarized light. The clockwise circularly polarized light transmits through the second quarter waveplate 32 again and is converted into the fourth linearly polarized light, and the fourth linearly polarized light is absorbed by the linear polarizer 11. Therefore, the second wavelength light incident on the optical system 1 from the observation side does not return from the optical system 1 to the observation side.

The counterclockwise circularly polarized light that has transmitted through the half-mirror 22 transmits through the first quarter waveplate 31 and is converted to the second linearly polarized light, but regardless of its polarization direction, it transmits through the PBS 21, exits the optical system 1, and travels toward the display element side.

Thus, a light component of the second wavelength light from the infrared light source 6 that has not been reflected within the optical system 1 enters the observer's eye. Then, the light component of the second wavelength light reflected by the eye that has not been reflected within the optical system 1 reaches the imaging unit 5. Thereby, good line-of-sight detection can be achieved through the imaging unit 5 disposed on the display element side.

In this embodiment, the second wavelength light emitted from the infrared light source 6 transmits through the optical system 1 and is irradiated onto the observation side, and the second wavelength light reflected by the eye on the observation side transmits through the optical system 1 and enters the imaging unit 5. Therefore, a general-purpose infrared camera can be used as the imaging unit 5, and a display apparatus can achieve good line-of-sight detection at low cost. In addition, the display apparatus can be smaller than that in the first embodiment.

In this embodiment, as described above, no return light is generated from the second wavelength light incident on the optical system 1 from the observation side back to the observation side. In a case where a corneal image formed by the second wavelength light reflected from the cornea is used for line-of-sight detection, the return light is generated, and the observer is wearing glasses, the light reflected multiple times between the return light and the glasses may reach the vicinity of the corneal image and interfere with line-of-sight detection. This embodiment can avoid such return light, and satisfactorily perform gaze detection using the corneal image.

### Third Embodiment

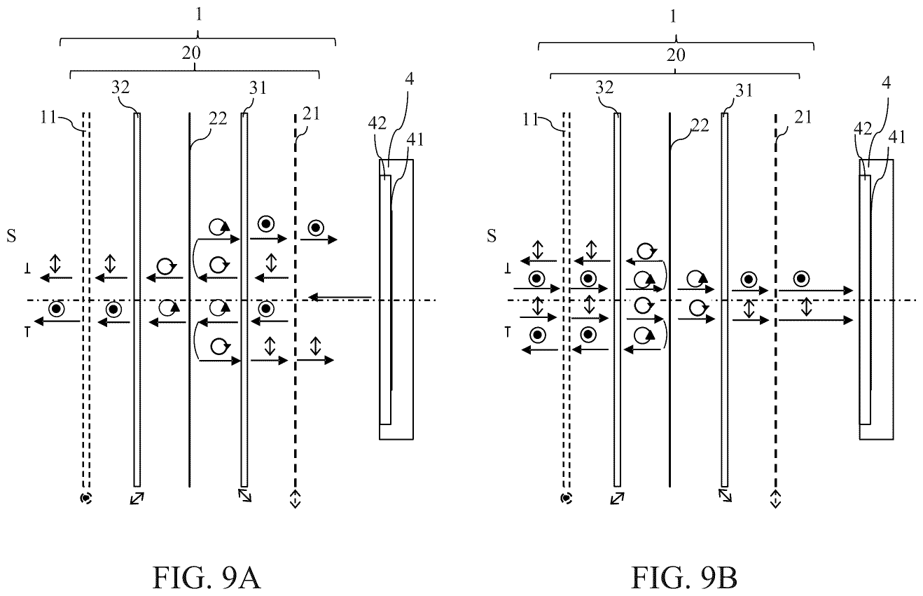

FIGS. 9A and 9B illustrate the configuration of a display apparatus according to a third embodiment. This display apparatus has a similar configuration to that of the display apparatus according to the second embodiment. In this embodiment, the PBS 21 and the linear polarizer 11 are both illustrated by broken lines in the figure as being incompatible with infrared light. This embodiment will also discuss the optical path in a case where it is assumed that each of the PBS 21 and the linear polarizer 11 has the ideal spectral transmittance characteristic described above for the second wavelength light.

FIG. 9A illustrates the polarization state and optical path of the second wavelength light emitted from the infrared light source 6 and entering the optical system 1 from the display element side. In the second embodiment illustrated in FIG. 8A, the first linearly polarized light of the second wavelength light that has entered the optical system 1 from the infrared light source 6 and transmitted through the PBS 21 is converted to the fourth linearly polarized light by transmitting through the first quarter waveplate 31, the half-mirror 22, and the second quarter waveplate 32, and is absorbed by the linear polarizer 11. On the other hand, in this embodiment, the first linearly polarized light of the second wavelength light that has entered the optical system 1 from the infrared light source 6 and transmitted through the PBS 21 is converted to the fourth linearly polarized light by transmitting through the first quarter waveplate 31, the half-mirror 22, and the second quarter waveplate 32, but is not absorbed by the linear polarizer 11 and travels toward the observation side.

The optical path of the second linearly polarized light of the second wavelength light that has entered the optical system 1 from the infrared light source 6 and transmitted through the PBS 21 is the same as that in the second embodiment.

In this embodiment, as in the second embodiment, the second wavelength light incident on the optical system 1 from the display element side transmits once each through the PBS 21 and the half-mirror 22, and a light component that further transmits through the linear polarizer 11 travels toward the observation side.

FIG. 9B illustrates the polarization state and optical path of the second wavelength light that is reflected by the observer's eye and enters the optical system 1 from the observation side.

The second wavelength light that has entered the optical system 1 from the observation side transmits through the linear polarizer 11 regardless of its polarization direction. In the second embodiment illustrated in FIG. 8B, the third linearly polarized light of the second wavelength light that has transmitted through the linear polarizer 11 transmits through the second quarter waveplate 32, is partially reflected by the half-mirror 22, transmits again through the second quarter waveplate 32, is converted into the fourth linearly polarized light, and is absorbed by the linear polarizer 11. On the other hand, in this embodiment, the third linearly polarized light of the second wavelength that has transmitted through the linear polarizer 11 transmits through the second quarter waveplate 32, is partially reflected by the half-mirror 22, and is converted into the fourth linearly polarized light by transmitting again through the second quarter waveplate 32, but is not absorbed by the linear polarizer 11 and returns to the observation side.

The second linearly polarized light that has transmitted through the half-mirror 22 and emitted from the first quarter waveplate 31 transmits through the PBS 21 as in the second embodiment and emits from the optical system 1 toward the display element side.

The fourth linearly polarized light of the second wavelength that has transmitted through the linear polarizer 11 transmits through the second quarter waveplate 32 and is converted into clockwise circularly polarized light. A part of the clockwise circularly polarized light is reflected by the half-mirror 22 and becomes counterclockwise circularly polarized light, which again transmits through the second quarter waveplate 32 and is converted into the third linearly polarized light, and then transmits through the linear polarizer 11 and returns to the observation side.

The clockwise circularly polarized light that has transmitted through the half-mirror 22 transmits through the first quarter waveplate 31 and is converted into the first linearly polarized light. The first linearly polarized light transmits through the PBS 21, exits the optical system 1, and travels toward the observation side.

Thus, a light component (nonpolarized light) of the second wavelength light from the infrared light source 6 that has not been reflected in the optical system 1 and has transmitted through the linear polarizer 11 is irradiated onto the observer's eye. Then, the light component of the second wavelength light that has been reflected by the eye and has not been reflected within the optical system 1 reaches the imaging unit 5. Thereby, good line-of-sight detection can be achieved through the imaging unit 5 disposed on the display element side.

In this embodiment, as in the second embodiment, the second wavelength light emitted from the infrared light source 6 transmits through the optical system 1 and is irradiated onto the observation side, and the second wavelength light reflected by the eye on the observation side transmits through the optical system 1 and enters the imaging unit 5. Thus, this embodiment can use a general-purpose infrared camera as the imaging unit 5, and the display apparatus can perform good gaze detection at low cost. In addition, the display apparatus can be smaller than in the first embodiment.

This embodiment can utilize all of the second wavelength light that has transmitted through the half-mirror 22 as illumination light for the observer's eye and imaging light for the imaging unit 5, so that the display apparatus can use the second wavelength light emitted from the infrared light source 6 with high efficiency.

### Fourth Embodiment

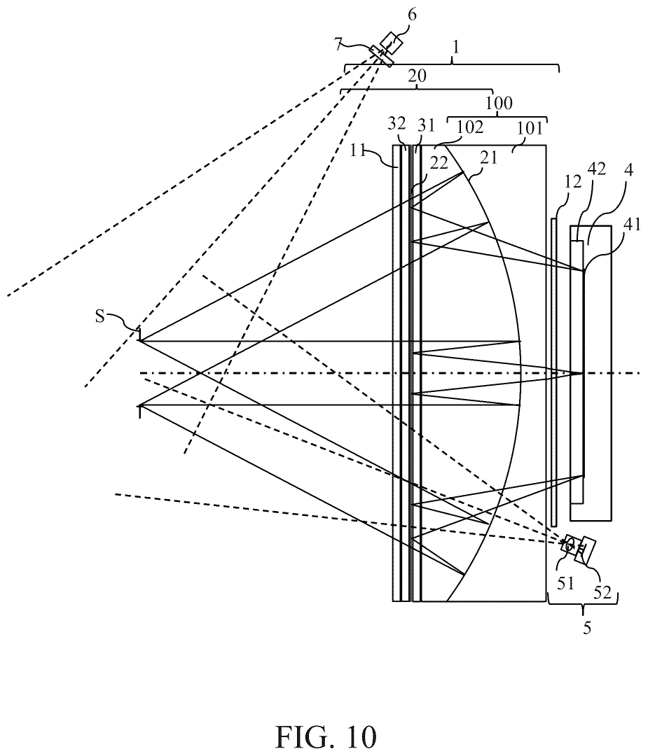

FIG. 10 illustrates the configuration of a display apparatus according to a fourth embodiment. The basic configuration according to this embodiment is the same as that of the first embodiment. This embodiment provides an absorptive polarizer 12 having a transmission axis in the same direction as that of the PBS 21 between the PBS 21 and the display element 4.

This configuration can reduce the unnecessary component (second linearly polarized light) contained in the first wavelength light incident on the PBS 21 from the display element 4 before it enters the PBS 21, and can further reduce the unnecessary component that may be contained in the first wavelength light transmitted through the PBS 21. Thereby, this embodiment can increase the contrast of the image displayed by the first wavelength light that has transmitted through the PBS 21.

### Fifth Embodiment

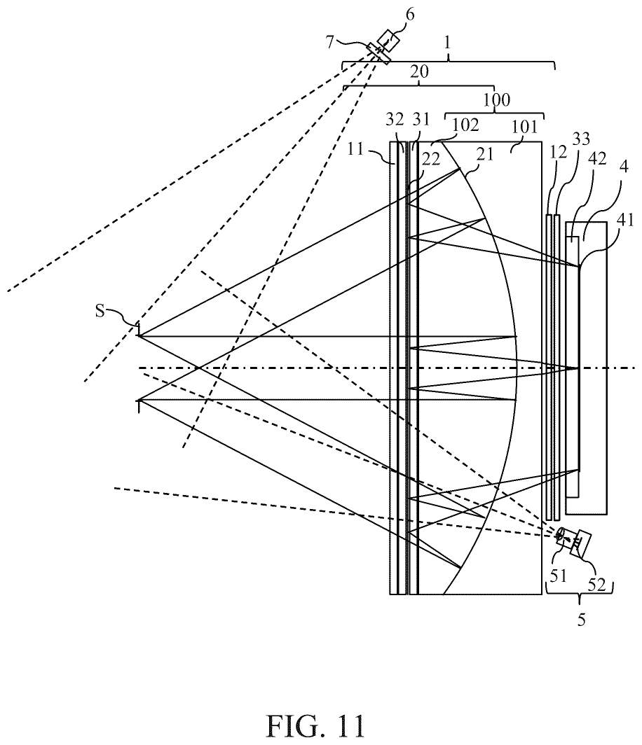

FIG. 11 illustrates the configuration of a display apparatus according to a fifth embodiment. The basic configuration of this embodiment is the same as that of embodiment 4. This embodiment provides a quarter waveplate 33 between the absorptive polarizer 12 and the display element 4 described in the fourth embodiment, and the slow axis of the quarter waveplate 33 is tilted by ±45° relative to the transmission axis of the absorptive polarizer 12.

This configuration can prevent a small amount of the first linearly polarized light reflected by the PBS 21 from being reflected by the display element 4 and becoming stray light.

### Sixth Embodiment

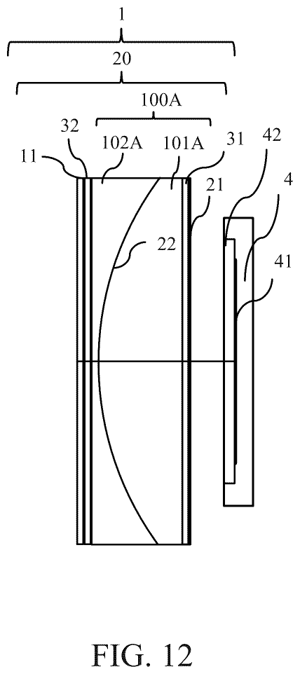

FIG. 12 illustrates the configuration of an optical system 1 in a display apparatus according to a sixth embodiment. In the lens units 100 according to the first to fifth embodiments, the plano-concave lens 101 and the plano-convex lens 102 are cemented together, the half-mirror 22 is formed to have a flat shape, and the PBS 21 is formed to have a curved shape. On the other hand, in a lens unit 100A according to this embodiment, a plano-convex lens 101A and a plano-concave lens 102A are cemented together, the half-mirror 22 is formed to have a curved shape, and the PBS 21 is formed to have a flat shape. In other words, the half-mirror 22 has power for reflection.

### Seventh Embodiment

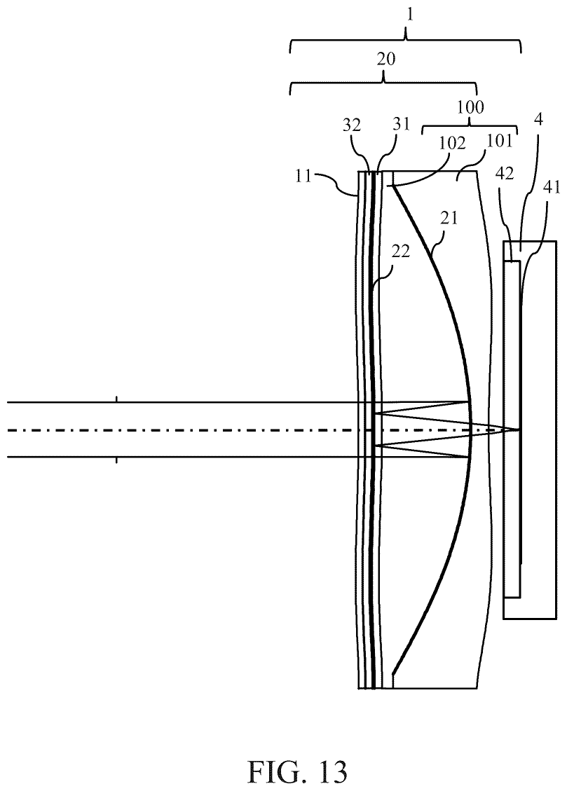

FIG. 13 illustrates the configuration of an optical system 1 in a display apparatus according to a seventh embodiment. In the lens units 100 according to the first to fifth embodiments, a plano-concave lens 101 and a plano-convex lens 102 are cemented together. On the other hand, in a lens unit 100B according to this embodiment, a concave lens 101B is cemented with curved surfaces on both sides and a convex lens 102B with curved surfaces on both sides. The concave lens 101B and the convex lens 102B do not necessarily have to be cemented together.

In cases where the optical system 1 has a plurality of curved surfaces or there is a difference in refractive index between the plurality of lenses in the lens unit, the reflective surface A, which is responsible for the main light condensing power of the first and second transmissive reflective surfaces, may satisfy the following inequality (6):

$$φ A / Φ \geq 0.8 \qquad ( 6 )$$

where φA is the power of the reflective surface A during reflection, and Φ is the power of the entire optical system 1.

Reducing the power of the other curved surfaces so as to satisfy this inequality can achieve good imaging performance in the optical system 1 and the imaging optical system 51 that form the imaging optical path without complicating the configuration of the imaging optical system 51.

### Display Apparatus 1

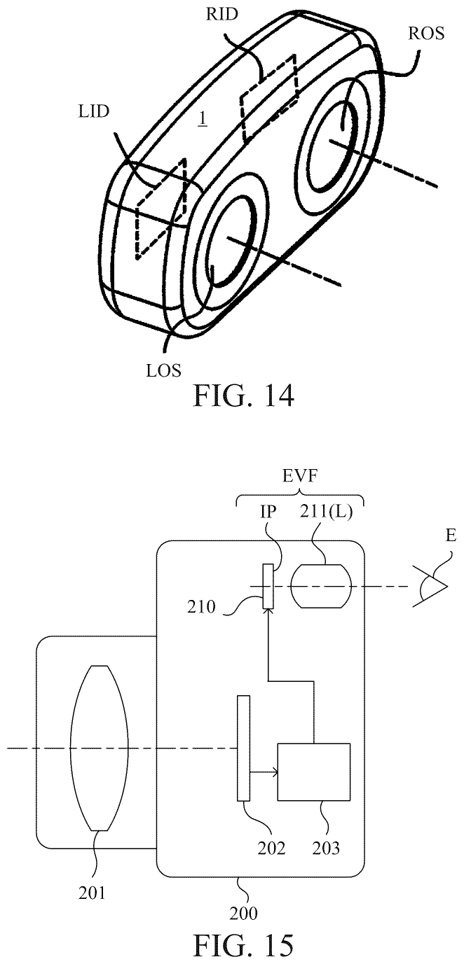

FIG. 14 illustrates an HMD as a specific example of the display apparatuses according to the first to seventh embodiments. The HMD is attached to the observer's head (in front of the eyes) by an unillustrated attachment gear.

The HMD includes right-eye and left-eye image display elements RID and LID, a right-eye display optical system ROS that guides display light from the right-eye image display element RID to the observer's right eye, and a left-eye display optical system LOS that guides display light from the left-eye image display element LID to the observer's left eye.

The HMD can have a reduced size using any one of the optical systems 1 according to the first to seventh embodiments as the right-eye and left-eye display optical systems ROS and LOS.

### Display Apparatus 2

FIG. 15 illustrates the configuration of an image pickup apparatus (simply referred to as a camera hereinafter) 200 such as a digital camera or video camera having an electronic viewfinder EVF as a specific example of the display apparatuses according to the first to seventh embodiments.

The camera 200 includes an imaging optical system 201, an image sensor 202 such as a CCD sensor or CMOS sensor that captures (photoelectrically converts) an unillustrated object image through the imaging optical system 201, and an image processing unit 203 that generates image data using a signal output from the image sensor 202.

The image data generated by the image processing unit 203 is output to a display element 210 of the electronic viewfinder EVF. The display element 210 displays an object image corresponding to the image data on its display surface IP.

The electronic viewfinder EVF includes an eyepiece optical system 211 that includes any one of the optical systems 1 according to the first to seventh embodiments. A user (observer) of camera 200 can observe an enlarged image of the object displayed on display element 210 through eyepiece optical system 211.

Using any one of the optical systems 1 according to the first to seventh embodiments as eyepiece optical system 211 enables a good image of the object to be observed on a compact electronic viewfinder.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment according to the disclosure can provide an optical system that can reduce ghosts caused by external light entering from the observation side, and enable good image observation and good line-of-sight detection.

This application claims the benefit of Japanese Patent Application No. 2024-172958, which was filed on Oct. 2, 2024, and which is hereby incorporated by reference herein in its entirety.

What is claimed is:

1. An optical system configured to guide first wavelength light from a display element to an observation side, the optical system comprising:
a first transmissive reflective surface configured to transmit first linearly polarized light and reflect second linearly polarized light having a polarization direction different from that of the first linearly polarized light;
a second transmissive reflective surface disposed on the observation side of the first transmissive reflective surface and configured to transmit a part of incident light and reflect another part regardless of a polarization direction of the incident light; and
an absorptive polarizer disposed on the observation side of the second transmissive reflective surface and configured to transmit third linearly polarized light and absorb fourth linearly polarized light having a polarization direction different from that of the third linearly polarized light,
wherein at least a part of the optical system guides second wavelength light, which is incident from the observation side and has a wavelength range different from that of the first wavelength light, to an imaging system,
wherein the following inequalities are satisfied:
$$Ts 11 / Tp 11 \leq 0.1$$
$$Ts 21 / Tp 21 \leq 0.1$$
where Tp11 and Ts11 are transmittances of the first transmissive reflective surface for the first linearly polarized light and the second linearly polarized light of the first wavelength, respectively, and Tp21 and Ts21 are transmittances of the absorptive polarizer for the third linearly polarized light and the fourth linearly polarized light of the first wavelength, respectively, and
wherein at least one of the following inequalities is satisfied:
$$Ts 12 / Tp 12 \geq 0.5$$
$$Ts 22 / Tp 22 \geq 0.5$$
where Tp12 and Ts12 are transmittances of the first transmissive reflective surface for the first linearly polarized light and the second linearly polarized light of the second wavelength light, respectively, and Tp22 and Ts22 are transmittances of the absorptive polarizer for the third linearly polarized light and the fourth linearly polarized light of the second wavelength light, respectively.

2. The optical system according to claim 1, wherein the first wavelength light is light in a visible wavelength range, and
wherein the second wavelength light is light in an infrared wavelength range.

3. The optical system according to claim 1, wherein the first wavelength light from the display element transmits through the first transmissive reflective surface, is reflected by the second transmissive reflective surface, is reflected by the first transmissive reflective surface, transmits through the second transmissive reflective surface, transmits through the absorbing polarizer, and is guided to the observation side.

4. The optical system according to claim 1, wherein in a case where the second wavelength light from a light source is irradiated to the observation side without passing through the optical system, is reflected on the observation side and enters the optical system, the following inequalities are satisfied:
$$Ts 12 / Tp 12 < 0.5$$
$$Ts 22 / Tp 22 \geq 0.5 .$$

5. The optical system according to claim 1, wherein in a case where the second wavelength light from a light source is irradiated to the observation side via at least a part of the optical system, is reflected on the observation side, and enters the optical system, the following inequalities are satisfied:
$$Ts 12 / Tp 12 \geq 0.5$$
$$Ts 22 / Tp 22 < 0.5 .$$

6. The optical system according to claim 1, wherein in a case where the second wavelength light from a light source is irradiated to the observation side via at least a part of the optical system, is reflected on the observation side, and enters the optical system, the following inequalities are satisfied:
$$Ts 12 / Tp 12 \geq 0.5$$
$$Ts 22 / Tp 22 \geq 0.5 .$$

7. The optical system according to claim 1, further comprising another absorptive polarizer between the first transmissive reflective surface and the display element.

8. The optical system according to claim 7, further comprising a quarter waveplate between the other absorptive polarizer and the display element.

9. The optical system according to claim 1, wherein one of the first transmissive reflective surface and the second transmissive reflective surface acts as a reflective surface having power, and
wherein the following inequality is satisfied:
$$1. 0 < LaA / fA \leq 2.5$$
where fA is a focal length during reflection of the reflective surface, and LaA is an air-equivalent optical path length of the first wavelength light from reflection at the reflective surface to a pupil plane of the optical system on the observation side.

10. A display apparatus comprising:
an optical system configured to guide first wavelength light from a display element to an observation side;
the display element;
an imaging system; and
a light source configured to emit second wavelength light to be irradiated to the observation side,
wherein the optical system includes:
a first transmissive reflective surface configured to transmit first linearly polarized light and reflect second linearly polarized light having a polarization direction different from that of the first linearly polarized light;
a second transmissive reflective surface disposed on the observation side of the first transmissive reflective surface and configured to transmit a part of incident light and reflect another part regardless of a polarization direction of the incident light; and
an absorptive polarizer disposed on the observation side of the second transmissive reflective surface and configured to transmit third linearly polarized light and absorb fourth linearly polarized light having a polarization direction different from that of the third linearly polarized light,
wherein at least a part of the optical system guides second wavelength light, which is incident from the observation side and has a wavelength range different from that of the first wavelength light, to an imaging system,
wherein the following inequalities are satisfied:
$$Ts 11 / Tp 11 \leq 0.1$$
$$Ts 21 / Tp 21 \leq 0.1$$
where Tp11 and Ts11 are transmittances of the first transmissive reflective surface for the first linearly polarized light and the second linearly polarized light of the first wavelength, respectively, and Tp21 and Ts21 are transmittances of the absorptive polarizer for the third linearly polarized light and the fourth linearly polarized light of the first wavelength, respectively, and
wherein at least one of the following inequalities is satisfied:
$$Ts 12 / Tp 12 \geq 0.5$$
$$Ts 22 / Tp 22 \geq 0.5$$
where Tp12 and Ts12 are transmittances of the first transmissive reflective surface for the first linearly polarized light and the second linearly polarized light of the second wavelength, respectively, and Tp22 and Ts22 are transmittances of the absorptive polarizer for the third linearly polarized light and the fourth linearly polarized light of the second wavelength, respectively.
